(19) United States
(12) Patent Application Publication
(10) Pub. No.: US 2014/0069590 A1
(43) Pub. Date: Mar. 13, 2014

(54) METHOD AND SYSTEM FOR APPLICATION OF VACUUM EVAPORATION TO THE THICKENING AND DRYING OF TAILINGS IN OILSANDS AND MINERAL MINING OPERATIONS

(71) Applicant: Bin-Siew Lim, Vancouver (CA)

(72) Inventor: Bin-Siew Lim, Vancouver (CA)

(21) Appl. No.: 14/023,597

(22) Filed: Sep. 11, 2013

Related U.S. Application Data
(60) Provisional application No. 61/700,586, filed on Sep. 13, 2012.

(51) Int. Cl. B01D 1/26

(52) U.S. Cl. CPC B01D 1/26
USPC 159/17.1; 159/47.1

(57) ABSTRACT

A method and system for dewatering tailings from oilsands or other mining operations using vacuum evaporation. The method comprises i) providing one or more vacuum chambers and means for delivering the tailings to the one or more vacuum chambers; ii) delivering the tailings to one or more vacuum chambers in sufficient volume to partially fill the one or more vacuum chambers; iii) reducing the pressure in each of the one or more vacuum chambers; iii) applying heat to the tailings before, and/or after and/or during such pressure reduction to thereby dewater the tailings; iv) measuring the density or moisture content of the dewatered tailings and withdrawing the tailings from the one or more vacuum chambers when a predetermined density or moisture content of the tailings in that vacuum chamber has been reached. A number of vacuum chambers in series can be used.

### REFERENCE TO RELATED APPLICATION

The present application claims the benefits, under 35 U.S.C.§119(e), of U.S. Provisional Application Ser. No. 61/700,586 filed Sep. 13, 2012 which is incorporated herein by this reference.

### TECHNICAL FIELD

The invention relates to the field of treatment of tailings from oilsands mining operations and mineral mining operations, and in particular the use of vacuum evaporation in such treatment.

### BACKGROUND

In oilsands and mineral mining operations, large quantities of tailings (liquid and solid wastes) are generated. Generally, the liquid wastes are stored in tailings pond constructed out of the solid wastes. The liquid wastes consist of water, chemicals and fine solid particles (silt, clay and clay sized particles). Because of the minute size of the fine solid particles, it takes a long time for such fine solid particles to settle out to the point where the water can be recycled and reused.

Oilsands consist of solids (fine sand, silt, clay and clay sized particles), bitumen and a trace amount of water. Typically, in oilsands mining operations, bitumen is extracted from the oilsands using a hot water process. Hot water, chemicals and solvents are added to the oilsands to allow extraction of the bitumen from the oilsands. Three waste streams result from this extraction process: namely, Coarse Sand Tailings (CST), Thickened Tailings (TT) and Tailings Solvent Recovery Unit (TSRU) tailings.

At the tailings pond location, solids from the CST are separated out for use to construct the dyke surrounding the tailings pond and the liquid waste (Thin Fine Tailings—TFT) flows into the tailings pond. Mature Fine Tailings result from the settling out of fine solid particles in the TFT. Typically, MFT contains about 30-35% of fine solid particles after a few years. Further increase in fine concentration through the natural settling process takes a very long time. As such, oilsands mining operators are obliged to maintain and be responsible for the tailings ponds for a very long time. Both TT and TSRU waste streams are discharged directly into the tailings pond for storage.

According to conventional treatment of tailings, typically, tailings are treated with flocculants or coagulants to flocculate/coagulate the clay and clay-sized particles to help bleed out excess water and accelerate settling of the fine particles. The flocculated/coagulated fine particles are deposited on open ground and allowed to dry out further. The bled water is pumped back to the tailings pond for storage. Typically, this process can bring the solid concentration up to about 60% and takes significant time as the process is highly dependent on natural process and weather. Other processes such as hydrocycloning and centrifuging have been tried and found not able to achieve the desired solid concentration within time and economic constraints.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention therefore provides a method of dewatering tailings from oilsands or other mining operations using vacuum evaporation, and a system for carrying it out. The method comprises i) providing one or more vacuum chambers and means for delivering the tailings to one or more vacuum chambers; ii) delivering the tailings to one or more vacuum chambers in sufficient volume to partially fill the one or more vacuum chambers; iii) reducing the pressure in each of the one or more vacuum chambers; iii) applying heat to the tailings before, and/or after and/or during such pressure reduction to thereby dewater the tailings; iv) measuring the density or moisture content of the dewatered tailings in at least one of said one or more vacuum chambers and withdrawing the tailings from the one or more vacuum chambers when a predetermined density or moisture content of the tailings in that vacuum chamber has been reached.

According to one aspect, before, and/or after and/or during the pressure reduction step, heat is applied to the tailings in said evacuation chamber by means of direct heating elements, such as radiant heat or microwave. A plurality of vacuum evaporation chambers may be arranged in series so that heated vapours removed from a first vacuum chamber are used to heat the tailings in a succeeding chamber.

The invention further provides a system for dewatering tailings from oilsands or other mining operations using vacuum evaporation, comprising: i) one or more vacuum chambers and means for delivering said tailings to the one or more vacuum chambers; ii) evacuation means for reducing the pressure in each of the one or more vacuum chambers; iii) heat transfer apparatus for transferring heat to the tailings before, and/or after and/or during such pressure reduction to thereby dewater the tailings; iv) a measurement device for measuring the density or moisture content of the dewatered tailings in at least one of the one or more vacuum chambers to determine when a predetermined density or moisture content of the tailings in at least one of the one or more vacuum chambers has been reached.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating the method of the invention.

FIG. 2 is a schematic diagram illustrating a vacuum pump and knock-out drum module which is associated with each vacuum drum and heat exchanger.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The present invention is preferably, although not exclusively, directed to a treatment of mature fine tailings (MFT) resulting from oilsands operations. Vacuum evaporation is a proven process that has been in use in the food processing and water treatment industries. This process is adapted in the present invention to thicken or dry the Mature Fine Tailings (MFT) for final disposal or as a pre-treatment for other disposal methods.

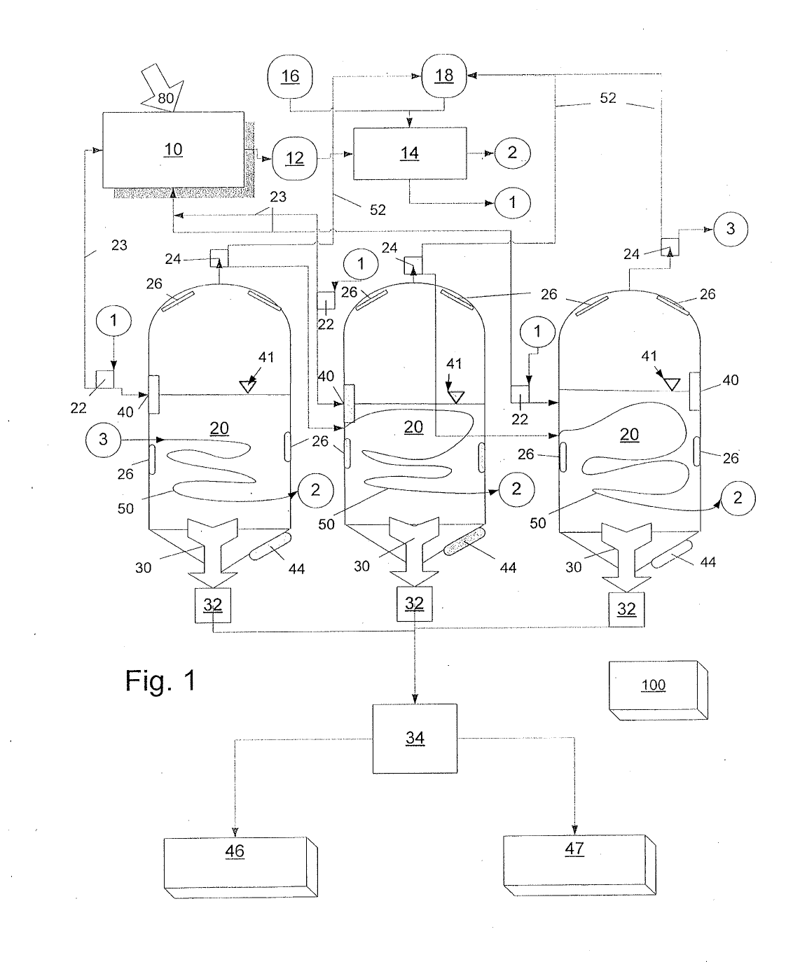

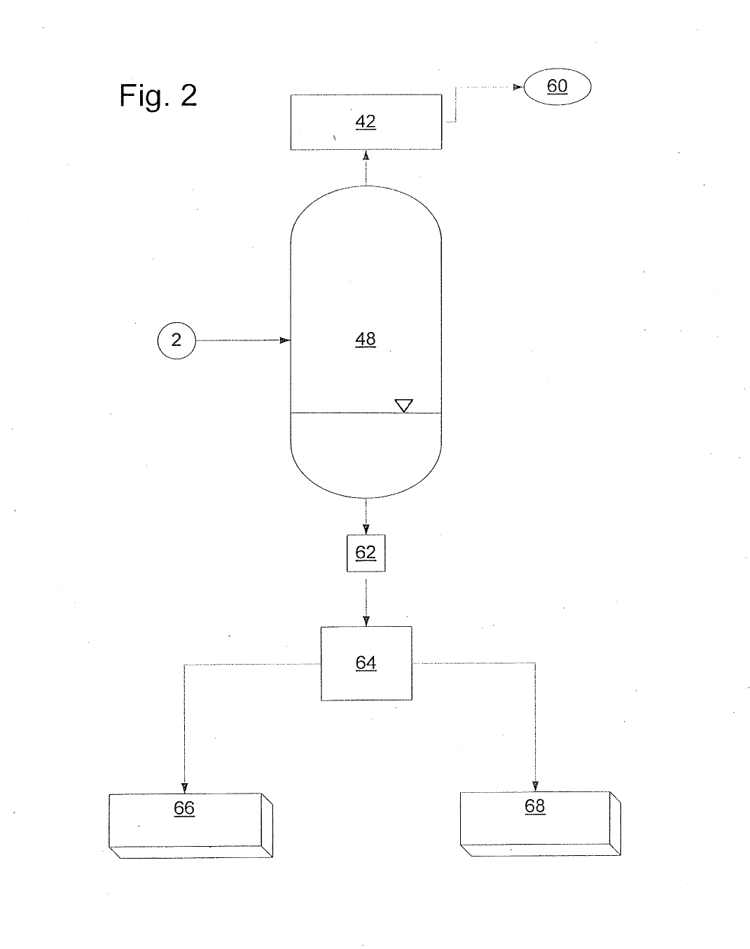

The method of application of vacuum evaporation to the treatment of MFT is shown on the attached schematic diagram, FIGS. 1 and 2 and described as follows.

First MFT 80 is drawn from the tailings pond and temporarily stored in a surge tank 10 to allow for a more flexible operation. The level of MFT in the vacuum chambers 20, shown by level indicators 41 is preset and controlled by the level controls 40 which incorporate level sensors in order to partially but not completely fill such chambers. When the level falls below the preset level, a signal is sent to initiate withdrawal of MFT from the MFT Surge Tank 10.

A Distributed Control System 100 (DCS), which may be any suitable industrial process controller, controls the various valves, switches, pumps and other control elements in the system and receives signals from the sensors described herein, using wireless or wired communication channels. Valves, switches, pumps and other control elements are of known available types, whether electrical, hydraulic, pneumatic etc.

For improved efficiency and reduction of environmental impact, the MFT first flows via charge pump 12 through a heat exchanger 14 for pre-heating with waste heat from plant 16 and/or evacuated steam 18 from the vacuum chambers through 3-way valves 24 and pipes 52. 3-way valve 22 is opened to vacuum chamber 20 and MFT is injected (shown through numeral 1) into the vacuum chambers 20 until the preset level is reached. When the preset level is reached, the pumping rate of pump 12 is reduced and valve 22 is switched so that MFT is returned to the MFT Surge Tank 10 through pipes 23.

Vacuum chambers 20 are each evacuated by a vacuum pump 42 (FIG. 2). Before, and/or after and/or during such evacuation, heat is applied to the injected MFT by means of direct heating elements 26, which may be radiant electric heating elements, gas fired, gas/electric radiant heating elements or micro-wave heating. Existing industrial quality heating elements can be used. Depending on the type of heating elements used, these can be located at the top or on the side of the vacuum chambers 20, in particular as radiant heating elements will be located above the surface 40 of the MFT whereas microwave elements can also be located below the level 40 of the MFT. The degree of vacuum and heating to be applied, and the number and location of heaters, is determined through experimentation because of the different nature of MFT from different oilsands mining operations and based on cost considerations. The higher the level of the vacuum, and thus the lower level of pressure in vacuum chambers 20, the lower level of heat that needs to be applied to achieve evaporation. The higher the pressure in the vacuum chambers, the higher the amount of heat required to be applied to achieve evaporation. Using heat alone for evaporation however will be costly, so a level of vacuum is most efficient. Chemicals may also be added to reduce surface tension of the liquid, such as entrained water, and thereby accelerate evaporation. A pilot plant may be constructed to determine the most effective combination of heat and vacuum for the MFT in any given installation. Vacuum chambers 20 and heat exchanger 14 and the heated interconnecting piping are insulated to prevent heat loss.

As the liquid phase of MFT is evaporated, the MFT is thickened and increases in density and sinks to the bottom. The density of the thickened MFT and percentage of remaining liquid can be determined with nuclear density and moisture meters 44 attached to the bottom of the vacuum chambers 20. Such meters can be appropriately certified combination gamma and neutron sensors, which are readily available.

Once the density and moisture meters 44 indicate that the target density and/or moisture content of thickened or dried MFT is achieved, a signal is sent to the DCS and the thickened MFT is withdrawn from the vacuum chambers 20 by means of a mechanical device such as auger extractors 30 driven by motors 32, and transfer pump 34. The withdrawn thickened or dried MFT can be disposed of in many ways as exemplified as follows:
1 Thickened MFT can be disposed of as is at pre-determined sites 46 or injected into deep wells for in-situ disposal.
2 Thickened MFT can be blended with dry soil such as dry CST from the dykes of tailings ponds and disposed at pre-determined sites 46.
3 Thickened MFT can also go through processes 47 such as addition of viscosity enhancement and hardening agents prior to disposal as described in item a & b.

To take advantage of the efficiency offered by multiple-effect evaporation, several (typically 3-4) vacuum evaporation chambers 20 can be arranged in series so that each succeeding chamber has a higher vacuum, or so that heated vapours removed from a first vacuum chamber are used to heat the tailings in a succeeding chamber To achieve this, each vacuum chamber has an associated vapor-liquid separator or knock-out drum 48 and vacuum pump 42 as shown in FIG. 2. The vapours from preceding chamber 20 may be used to evaporate and thicken the MFT in the subsequent chamber 20 through 3-way valves 24 and stainless steel coils 50 which are in contact with the MFT. Alternatively, the evacuated heated vapours may be routed back to the heat exchanger 14 through 3-way valves 24 and pipes 52 to preheat the incoming MFT from the MFT Surge Tank 10 in heat exchanger 14. In either case, the evacuated vapours are then conducted as indicated by numeral 2 to a knock-out drum 48 where the air and liquid phase of the evacuated vapours are separated out, with air being vented to vent 60 and condensed liquid through drain 62 and pumped through pump 64. Depending on the needs of the operation, the liquid phase (condensate) can be returned to recycle/process water supply pond at 66 for re-use or disposed of as per local regulations at 68. The tailings can also be directed into the subsequent vacuum chamber 20, with a higher degree of vacuum, rather than being first directed to transfer pump 34.

The size of the system shown in FIGS. 1 and 2 can be scaled to any level. It can be designed as a portable system contained in a transport container with vacuum chambers for example 1 metre in diameter or can be 10 times larger or more.

The MFT treatment process as described herein offers several advantages over other treatment processes, namely:
The process is fully under the control of the oilsands mining operators rather than leaving the process up to natural process.
Quality and quantity of treated MFT can be pre-determined to meet the needs of the oilsands mining operators, scaling the installation as appropriate.
The process will produce condensate (water) that is essentially free of chemicals and can be recycled for use in the extraction process.
The process equipment uses a small area of land.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of dewatering tailings from oilsands or other mining operations using vacuum evaporation, comprising:
i) providing one or more vacuum chambers and means for delivering said tailings to said one or more vacuum chambers;
ii) delivering said tailings to said one or more vacuum chambers in sufficient volume to partially fill said one or more vacuum chambers;
iii) reducing the pressure in each said one or more vacuum chambers;
iii) applying heat to said tailings before, and/or after and/or during such pressure reduction to thereby dewater the tailings;
iv) measuring the density or moisture content of the dewatered tailings in at least one of said one or more vacuum chambers and withdrawing the tailings from said one or more vacuum chambers when a predetermined density or moisture content of the tailings in said at least one of said one or more vacuum chambers has been reached.

2. The method of claim 1 wherein said tailings are drawn from a tailings pond and temporarily stored in a surge tank prior to said delivery step.

3. The method of claim 1 wherein a predetermined level of tailings in said one or more vacuum chambers is controlled by level controls.

4. The method of claim 1 wherein controls valves, switches, pumps and sensors are provided to automate the method and a process controller controls said valves, switches and pumps and based on signals received from said sensors.

5. The method of claim 1 wherein said tailings are pre-heated in a heat exchanger prior to delivery to said one or more vacuum chambers

6. The method of claim 1 wherein before, and/or after and/or during said pressure reduction step, heat is applied to said tailings in said evacuation chamber by means of direct heating elements.

7. The method of claim 1 wherein said direct heating elements are radiant heating elements or micro-wave heating elements.

8. The method of claim 1 wherein chemicals are added to said tailings to reduce surface tension of the entrained water and accelerate evaporation.

9. The method of claim 1 wherein a plurality of vacuum evaporation chambers are arranged in series so that heated vapours removed from a first vacuum chamber are used to heat the tailings in a succeeding chamber.

10. The method of claim 1 wherein a plurality of vacuum evaporation chambers are arranged in series so that each succeeding chamber has a higher vacuum and tailings are transferred to each successive chamber in series.

11. The method of claim 1 wherein each vacuum chamber has an associated vapor-liquid separator and vacuum pump for removal and disposal of evaporated liquid, and comprising the further step of removing and disposing of evaporated liquid from said tailings.

12. The method of claim 9 wherein vapours from a preceding chamber are used to heat the tailings in a subsequent chamber by direct contact through coils.

13. The method of claim 1 wherein evacuated heated vapours from said one or more vacuum chambers are used to preheat incoming tailings.

14. The method of claim 1 comprising the further step of determining the most effective combination of heat and vacuum for dewatering said tailings in an installation and adjusting the degree of heating and vacuum applied based on that determination for use in subsequent dewatering.

15. A system for dewatering tailings from oilsands or other mining operations using vacuum evaporation, comprising:
i) one or more vacuum chambers and means for delivering said tailings to said one or more vacuum chambers;
ii) evacuation means for reducing the pressure in each said one or more vacuum chambers;
iii) heat transfer apparatus for transferring heat to said tailings before, and/or after and/or during such pressure reduction to thereby dewater the tailings;
iv) a measurement device for measuring the density or moisture content of the dewatered tailings in at least one of said one or more vacuum chambers to determine when a predetermined density or moisture content of the tailings in said at least one of said one or more vacuum chambers has been reached.

16. The system of claim 15 wherein said heat transfer apparatus are radiant heating elements or micro-wave heating elements.

17. The system of claim 15 wherein vapours from a preceding chamber are used to heat the tailings in a subsequent chamber by direct contact through coils.

18. The system of claim 15 wherein wherein a plurality of vacuum evaporation chambers are arranged in series so that heated vapours removed from a first vacuum chamber are used to heat the tailings in a succeeding chamber.

19. The system of claim 15 wherein evacuated heated vapours from said one or more vacuum chambers are used to preheat incoming tailings.

20. The system of claim 15 wherein wherein a plurality of vacuum evaporation chambers are arranged in series so that each succeeding chamber has a higher vacuum and tailings are transferred to each successive chamber in series.
